(19) United States
(12) Patent Application Publication
(10) Pub. No.: US 2026/0197247 A1
(43) Pub. Date: Jul. 9, 2026

(54) METHOD AND APPARATUS FOR CONTROLLING ARTIFICIAL INTELLIGENCE MODELS IN A COMMUNICATION SYSTEM

(71) Applicant: SAMSUNG ELECTRONICS CO., LTD., Suwon-si, Gyeonggi-do (KR)

(72) Inventors: Yue WANG, Staines, Middlesex (GB); Daniel WARREN, Staines, Middlesex (GB)

(21) Appl. No.: 19/134,119

(22) PCT Filed: Jul. 19, 2023
(86) PCT No.: PCT/KR2023/010436

§ 371 Date: May 29, 2025

(30) Foreign Application Priority Data
Dec. 2, 2022 (GB) 2218127.5
Jun. 12, 2023 (GB) 2308754.7

(51) Int. Cl. H04L 41/16; H04L 41/14

(52) U.S. Cl. CPC H04L 41/16; H04L 41/145

(57) ABSTRACT

The disclosure relates to a 5G or 6G communication system for supporting a higher data transmission rate. The subject-matter of the present disclosure relates to a first network node for artificial intelligent (AI) management function in a communication system. The first network node comprises a transceiver; and a controller coupled with the transceiver and configured to: receive, from a second network node and a third network node, status information, receive, from a fourth network node, network information, determine an action to be performed by the second network node and the third network node based on the status information and the network information, transmit, to the second network node and the third network node, a control signal to perform the determined action, and receive, from the second network node and the third network node, an acknowledgment that the action is performed, wherein the second network node and the third network node comprise artificial intelligence function or data analytics function.

### TECHNICAL FIELD

The disclosure relates to management of artificial intelligence models operating across different layers of a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The use of AI for network management and operation has been a major technology trend as 5G networks become more sophisticated, and begin to form the basis of 6G networks. AI techniques, when applied to adjust network functions and resources based on changes in user needs, environmental conditions, and business goals, are expected to provide significant improvements in the experience of users (in terms of quality of experience (QoE)) as well as offering benefits to operators (in terms of reduction in CapEx, OpEx, improvements in operational capabilities and self-management of networks).

It is envisaged that in a 6G network, the use of AI will become widespread across the network. As a result, a 6G network will incorporate a large number of AI models, distributed across different locations, components and layers of the network. They will be placed (and deployed) in different part of the networks, accomplishing different intelligent tasks individually or collectively.

Current network architecture has evolved to support AI and data analytics in the network, including allowing AI and data analytics to make decisions that are then conveyed to the network, to address one or multiple intelligent tasks in the network-by way of examples, intelligent tasks include AI-enabled energy saving, AI-enabled handover optimization, AI-enabled capacity and coverage optimization, AI-enabled service assurance, AI-enabled anomaly detection, etc. Such AI and data analytics functions are being developed and specified in an open radio access network (O-RAN) and the third generation partnership project (3GPP). Examples of these functions and AI and data analytics models include functionality behind a network data analytics function (NWDAF), a management data analytics function (MDAF) in 3GPP, and xApps and rApps in O-RAN. In addition, recently there has been the development of new network functions in the 5GC to support Federated learning applications. Existing technologies also include embedded AI in one or multiple network functions across network domains, for example, a centralized AI model that monitors and serves all base stations in a region, or an AI that enables service level assurance across a network slice. It is commonly understood that in all these cases, one or more AI models can be deployed in different layers, components, and functions of the networks. For example, one or multiple AI models can be used to turn the base station on and off to reduce energy consumption of the base stations. In this example, the AI models can be deployed at one or multiple base stations, or as a separate intelligent entity interacting with all base stations.

Throughout the disclosure, one or more AI models also include network functions and sub-functions with data analytics capabilities. In the description that follows, we refer to any of these AI and data analytics functions as AI models, AI functions, and AI-enabled network functions interchangeably.

So far, AI-enabled networks allow the interaction of AI and network through the standardized network interfaces. For example, in 3GPP, such an interaction is rep-resented by a ‘request→response’ model between one single intelligent system and one single assisted system (a paired system). In 3GPP, the interaction may be directly from NWDAF to a consumer network function (NF) (clause 6.1.1 in 23.288), or through an intermediate NF (e.g., NEF). In O-RAN, an example of such an interface is between the near-real-time RAN intelligent controller (RT RIC) and the E2 nodes, via the E2 interface. There have no interfaces that have been specified to allow AI model management and orchestration in a communications network end-to-end.

Despite a foreseeable network with a number of AI models applied throughout such a network, at the moment, there is a lack of management and orchestration of the AI functions and models in a network end-to-end, to enable them to coexist and work in-teractively and collaboratively to complete an intelligent task. There is a clear need to manage, orchestrate, and broker multiple AI models across the network. For example, an AI model for energy saving needs to work together with another for QoE optimization, such that QoS enforcement decisions can be made without excessively consuming network resources and/or energy. As another example, AI-enabled mobility optimization may need to be jointly designed with radio resource management because the decisions of handing over UEs can negate the optimality of resource management. In addition, AI model placement (and splitting of their training and inference) need to be designed according to the communication and computation resources. AI models need to be properly life-cycle managed for energy and computational efficiency, as well as managing conflicts among the different AI models.

FIG. 1 illustrates a block diagram of a 3GPP network according to the related art.

FIG. 1 depicts an example of an abstracted network, with AI models across the network, under the existing 3GPP architecture. FIG. 1 describes AI models and AI-enabled network functions. Examples of these are AI models at the core network, e.g., for analytical information of UE positions, optimization of an inactive timer, and data analytics-enabled network functions within MDAF and NWDAF.

FIG. 2 illustrates a block diagram of an O-RAN network according to the related art;

FIG. 2 depicts an example of an abstracted network, with AI models across the network, under the existing O-RAN architecture. FIG. 2 describes AI models and AI-enabled network functions (e.g., rAPP1, xAPP2, [symbol] ). Examples of these are AI models at the RAN, e.g., AI-enabled load balancing and energy saving. It is noted that in O-RAN architecture, there is existence of the ‘AI management functions’ that are responsible for xApp (AI models) subscription, conflict mitigation, and management services. We refer to such a new entity in the network, which manages and orchestrates the AI models in the network end to end, as ‘AI management entity (function)’ or ‘AI management function’. It is noted that in O-RAN WG2 and WG3, although there is a definition of some AI management functions in near-RT RIC and non-RT RIC, they are located in different layers and components of the network, addressing specifically the management of xApps and rApps on a use case by use case basis, without the needed coordination among themselves—for example, a rApp management function would only manage the rApps, without knowing the impacts from the xApps if not through the A1 interface. Similarly, the xApps management function can only manage the conflict mitigation among xApps. In practical networks, however, an energy-saving rApp would need to have the knowledge and impact from a handover optimization xApp.

In addition, the current network architecture supports a ‘hierarchical’ model of interacting among different AI management entities.

FIG. 3 illustrates a block diagram of an O-RAN network according to the related art.

FIG. 3 gives the current architecture and model of interacting using O-RAN architecture as an example, although it is understood that the concept applies to existing 3GPP network as well. Non-relevant signalling and procedures are omitted in the figure for simplicity. In particular, the figures show the existing hierarchical architecture and messaging flow where rApps and xApps are managed by non-RT RIC and Near-RT RIC AI management functions, respectively, and information is passed via A1 and E2 interfaces. However, there is currently no interaction on the xApp/rApp level.

It is noted that the current AI management functions, located in different layers and domains of the network, manage the AI models of their specific domain/layer separately. The interactions of the AI models, as well as AI management functions, rely on the interfaces between non-RT RIC and RT-RIC (as in an O-RAN architecture), or between RAN and Core (as in a 3GPP architecture). This increases overhead and latency and does not facilitate the interaction and collaboration between AI models across layers and domains.

Significant problems may occur due to the lack of an overarching AI management function in the network end to end, for example, when different AI models in the system take conflict actions.

FIG. 4 illustrates a graph of network performance associated with the related art.

FIG. 4 gives an example of when such problems may occur. In this scenario, both AI model 1 and AI model 2 are taking local network contexts and their required KPIs as input, and make decisions to increase the number of PRBs (physical resource blocks) at the same time instant t. AI model 1's output action is to increase 20 PRBs for slice 1, and AI model 2's output action is to increase 40 PRBs for slice 2. In the existing network, there are mechanisms for both AI models to check that the system has sufficient PRBs (say a total of 40) to meet their required number of PRBs, therefore they would both take the actions. However, essentially the system does not have a sufficient number of total required PRBs for both AI models. But because the AI models, as well as the system, don't have visibility of the other AI models' action at time t, it may result in that action of at least one AI model to fail, causing system performance degradation. At the moment, in the existing system, there are no such mechanisms to decide what to do in such a situation. In particular, AI model 1 may sit at the RAN network, AI model 2 may sit at the Core network, and there is no such an overarching AI management function that would oversee the operations of all AI models across the network end to end, to make sure no conflicts occur among the AI models.

Conflict mitigation is just one of the examples where such an end-to-end AI management function is needed and would benefit the system. Processing and decisions from the AI management function can help, for example, schedule, priorities, mitigate conflicts, optimize the placement of partial, one, or multiple AI models in the network, enhance network performance, reduce the cost of running AI models, and enhance efficiency of AI models according to the system communication (e.g., number of PRBs) and computation (e.g., number of CPU cycles) resources.

It is an aim of the subject matter of the present disclosure to improve on the prior art.

### DISCLOSURE OF INVENTION

### Solution to Problem

The disclosure describes a new network function and interfaces, which support the management of AI model orchestration and management, referred to as, ‘AI management function’ or ‘AI management entity (function)’, interchangeably in the disclosure. This new network function facilitates the management and orchestration of AI models in a communication network, end to end.

Examples of managing and orchestrating AI models include one or multiple of the following, but not limited to:
conflict mitigation
lifecycle management
priority setting and management
AI model placement

Accordingly, the present disclosure provides embodiments that are designed to address at least the problems and/or disadvantages described above and to provide at least the advantages described below.

According to a first aspect of the present invention, there is provided a first network node for artificial intelligent (AI) management function in a communication system. The first network node comprises a transceiver; and a controller coupled with the transceiver and configured to: receive, from a second network node and a third network node, status information, receive, from a fourth network node, network information, determine an action to be performed by the second network node and the third network node based on the status information and the network information, transmit, to the second network node and the third network node, a control signal to perform the determined action, and receive, from the second network node and the third network node, an acknowledgment that the action is performed, wherein the second network node and the third network node comprise artificial intelligence function or data analytics function.

In an embodiment, a method of first network node for artificial intelligent (AI) management function in a communication system comprises receiving, from a second network node and a third network node, status information, receiving, from a fourth network node, network information, determining an action to be performed by the second network node and the third network node based on the status information and the network information, transmitting, to the second network node and the third network node, a control signal to perform the determined action, and receiving, from the second network node and the third network node, an acknowledgment that the action is performed, wherein the second network node and the third network node comprise artificial intelligence function or data analytics function.

In an embodiment, there is provided a controller for controlling first and second artificial intelligence models of a communications network, the controller comprising: an input configured to receive status information from the first and second artificial intelligence models, and to receive network information from the communications network; a determination module configured to determine an action to be performed by the first and/or the second artificial intelligence models based on the received status information and the received network information; an output configured to sending a control signal to the first and/or the second artificial intelligence models to perform the determined action, wherein the input is also configured to receive an acknowledgment from the first and/or second artificial intelligence models that the action has been performed. The term “controlling” may be used to mean operating and managing.

In an embodiment, the output may be configured to send the control signal to the communications network. In this way, the controller can interact with the first and/or second AI models directly or indirectly via the communications network. In such a case, the input may also be configured to receive the acknowledgment from the network. The communications network may be a telecommunications network.

In an embodiment, the status information comprises one or more items of status information selected form a list of status information including: a state, information on shared layers, priority, and intent of actions.

In an embodiment, the intent of actions comprises a number of physical resource blocks of the communications network that the first or the second AI model intends to use when performing the action.

In an embodiment, the action comprises one or more actions selected from a list of actions including: initializing the first and/or second artificial intelligence model, prioritising the first and/or the second artificial intelligence model, deprioritizing the first and/or the second artificial intelligence model, registering the first and/or the second artificial intelligence model, deregistering the first and/or the second artificial intelligence model, mitigating conflict between the first and the second artificial intelligence models, managing a life cycle of the first and/or the second artificial intelligence models, and placement of the first and or the second artificial intelligence models.

In an embodiment, the communications network is an open radio access network, O-RAN, and wherein the first artificial intelligence model is one of a first network automation tool, rApp, at a level of a non-real-time RAN intelligent controller, non-RT RIC, a second network automation tool, xApp, at a level of a near-real-time RAN intelligence controller, near-RT RIC, or an artificial intelligence model at a level of an E2 node, and wherein the second artificial intelligence model is a different one of the first network automation tool, rApp, at a level of a non-real-time RAN intelligent controller, non-RT RIC, a second network automation tool, xApp, at a level of a near-real-time RAN intelligence controller, near-RT RIC, or an artificial intelligence model at a level of an E2 node.

In an embodiment, the output is communicatively linked directly with the first and the second artificial intelligence models.

In an embodiment, the output is communicatively linked indirectly with the first and the second artificial intelligence models via a respective management module, wherein the management module of the first network automation tool, rApp, is a first network automation tool, rApp, management module, wherein the management module of the second network automation tool, xApp, is a second network automation tool, xApp, management module, and wherein the management module of the artificial intelligence model at a level of the E2 node is an E2 artificial intelligence model management module.

In an embodiment, wherein the communications network is a third-generation partnership project, 3GPP, network, wherein the first artificial intelligence model is one of a management data analytics function, MDAF, at a level of a service layer of the 3GPP network, a network data analytics function, NWDAF, at a level of a core network layer of the 3GPP network, and a radio access network artificial intelligence model, RAN, AI model, at a level of a radio access network, RAN, of the 3GPP network, and wherein the second artificial intelligence model is a different one of a management data analytics function, MDAF, at a level of a service layer of the 3GPP network, a network data analytics function, NWDAF, at a level of a core network layer of the 3GPP network, and a radio access network artificial intelligence model, RAN, AI model, at a level of a radio access network, RAN, of the 3GPP network.

In an embodiment, the input is configured to receive a request for action from the first and/or the second artificial intelligence algorithms, wherein the determination module is configured to determine the action to be performed by the first and/or the second artificial intelligence models, based on the received status information and the received network information, in response to the received request.

In an embodiment, the first artificial intelligence model and the second artificial intelligence model are at different levels of the communications network.

According to an aspect of the present inventions, there is provided a method of controlling first and second artificial intelligence models of communications network, the controller comprising: receiving status information from the first and second artificial intelligence models, and to receive network information from the communications network; determining an action to be performed by the first and/or the second artificial intelligence models based on the received status information and the received network information; sending a control signal to the first and/or the second artificial intelligence models to perform the determined action; and receiving an acknowledgment from the first and/or second artificial intelligence models that the action has been performed.

In an embodiment, the status information comprises one or more items of status information selected form a list of status information including: a state, information on shared layers, a priority, and an intent of actions.

In an embodiment, the intent of actions comprises a number of physical resource blocks of the communications network that the first or the second AI model intends to use when performing the action.

In an embodiment, the action comprises one or more actions selected from a list of actions including: initializing the first and/or second artificial intelligence model, pri-oritizing the first and/or the second artificial intelligence model, deprioritizing the first and/or the second artificial intelligence model, registering the first and/or the second artificial intelligence model, deregistering the first and/or the second artificial intelligence model, mitigating conflict between the first and the second artificial intelligence models, managing a life cycle of the first and/or the second artificial intelligence models, and placement of the first and or the second artificial intelligence models.

In an embodiment, the communications network is an open radio access network, O-RAN, and wherein the first artificial intelligence model is one of a first network automation tool, rApp, at a level of a non-real-time RAN intelligent controller, non-RT RIC, a second network automation tool, xApp, at a level of a near-real-time RAN intelligence controller, near-RT RIC, or an artificial intelligence model at a level of an E2 node, and wherein the second artificial intelligence model is a different one of the first network automation tool, rApp, at a level of a non-real-time RAN intelligent controller, non-RT RIC, a second network automation tool, xApp, at a level of a near-real-time RAN intelligence controller, near-RT RIC, or an artificial intelligence model at a level of an E2 node.

In an embodiment, the sending the control signal comprises sending the control signal directly to the first and the second artificial intelligence models.

In an embodiment, the sending the control signal comprises sending the control signal indirectly to the first and the second artificial intelligence models via a respective management module, wherein the management module of the first network automation tool, rApp, is a first network automation tool, rApp, management module, wherein the management module of the second network automation tool, xApp, is a second network automation tool, xApp, management module, and wherein the management module of the artificial intelligence model at a level of the E2 node is an E2 artificial intelligence model management module.

In an embodiment, the communications network is a third-generation partnership project, 3GPP, network, wherein the first artificial intelligence model is one of a management data analytics function, MDAF, at a level of a service layer of the 3GPP network, a network data analytics function, NWDAF, at a level of a core network layer of the 3GPP network, and a radio access network artificial intelligence model, RAN, AI model, at a level of a radio access network, RAN, of the 3GPP network, and wherein the second artificial intelligence model is a different one of a management data analytics function, MDAF, at a level of a service layer of the 3GPP network, a network data analytics function, NWDAF, at a level of a core network layer of the 3GPP network, and a radio access network artificial intelligence model, RAN, AI model, at a level of a radio access network, RAN, of the 3GPP network.

In an embodiment, the method further comprises: receiving a request for action from the first and/or the second artificial intelligence algorithms; and the determining the action to be performed by the first and/or the second artificial intelligence models, based on the received status information and the received network information, in response to the received request.

In an embodiment, the first artificial intelligence model and the second artificial intelligence model are at different levels of the communications network.

These and other aspects of the present invention will be apparent from and elucidated with reference to the embodiment(s) described hereinafter.

### BRIEF DESCRIPTION OF DRAWINGS

The above and other aspects, features, and advantages of certain embodiments of the disclosure will be more apparent from the following detailed description taken in con-junction with the accompanying drawings, in which:

FIG. 1 illustrates a block diagram of a 3GPP network according to the related art;

FIG. 2 illustrates a block diagram of an O-RAN network according to the related art;

FIG. 3 illustrates a block diagram of an O-RAN network according to the related art;

FIG. 4 illustrates a graph of network performance associated with the related art;

FIG. 5 illustrates a block diagram of an O-RAN communications network embodying a controller according to one or more embodiments;

FIG. 6 illustrates a block diagram of an O-RAN communications network embodying a controller according to one or more embodiments;

FIG. 7 illustrates a block diagram of a 3GPP communications network embodying a controller according to one or more embodiments;

FIG. 8 illustrates a flow chart of operations performed in an O-RAN communications network;

FIG. 9 illustrates a flow chart of operations performed in an O-RAN communications network according to one or more embodiments;

FIG. 10 illustrates a flow chart of operations performed in an O-RAN communications network according to one or more embodiments;

FIG. 11 illustrates a flow chart of operations performed in a communications network according to one or more embodiments;

FIG. 12 illustrates a flow chart of operations performed in a communications network according to one or more embodiments;

FIG. 13 illustrates a block diagram of an O-RAN communications network embodying the controller according to one or more embodiments;

FIG. 14 illustrates a block diagram of an O-RAN communications network embodying the controller according to one or more embodiments;

FIG. 15 illustrates a block diagram of a 3GPP communications network embodying the controller according to one or more embodiments;

FIG. 16 illustrates a block diagram of an O-RAN communications network embodying the controller according to one or more embodiments;

FIG. 17 illustrates a block diagram of a communications network embodying the controller according to one or more embodiments; and

FIG. 18 illustrates a flow chart summarising a method of controlling first and second artificial intelligence models in a communications network according to one or more embodiments.

FIG. 19 illustrates a schematic diagram of a network entity for AI management function according to an embodiment of the disclosure.

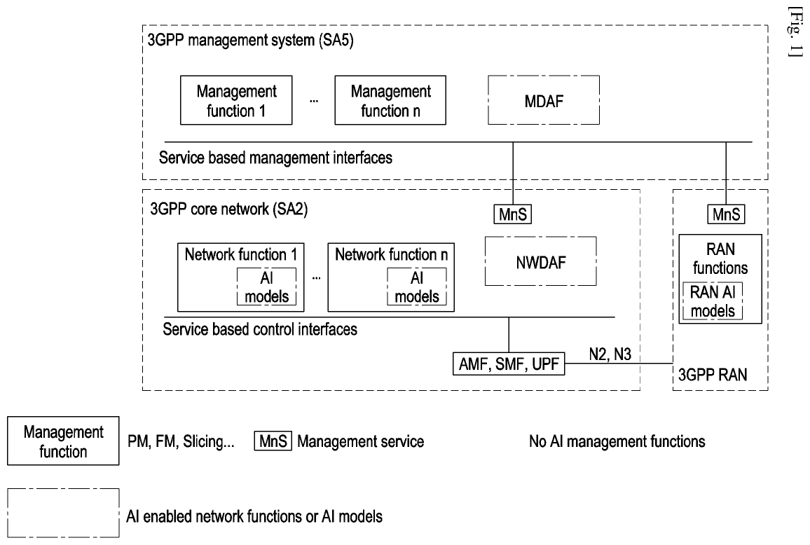

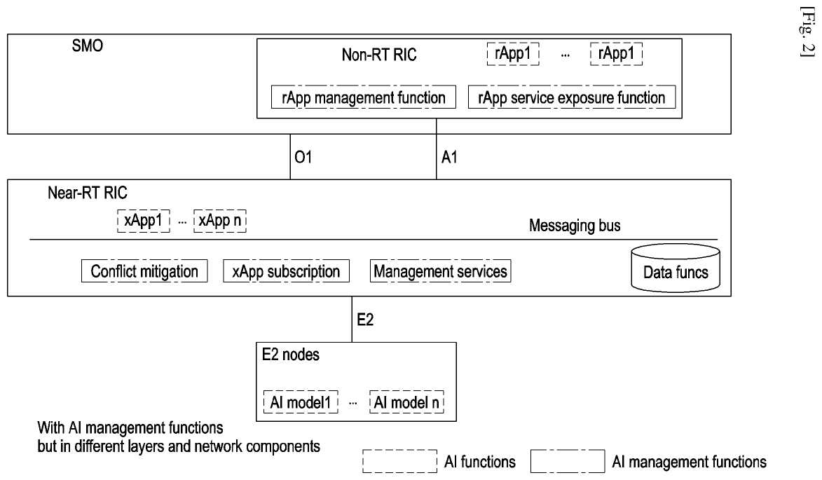

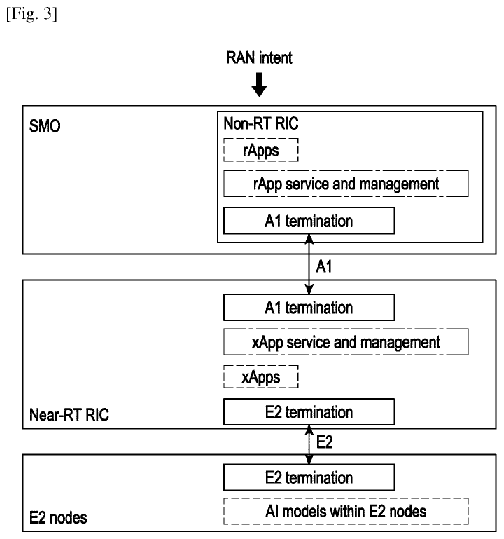

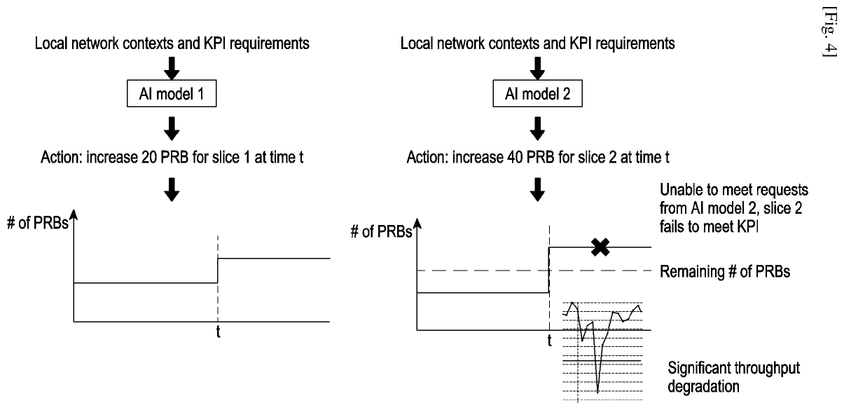

### MODE FOR THE INVENTION

The following description with reference to the accompanying drawings is provided to assist in a comprehensive understanding of the embodiments of the disclosure. It includes various specific details to assist in that understanding but these are to be regarded as merely examples. Accordingly, those of ordinary skill in the art will recognize that various changes and modifications of the embodiments described herein can be made without departing from the scope and spirit of the present disclosure. In addition, descriptions of well-known functions and constructions may be omitted for the sake of clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of embodiments of the disclosure is provided for illustration purposes only and not for the purpose of limiting the present disclosure.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation, or component which can be used in embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a pos-sibility of addition of one or more other characteristics, numbers, steps, operations, constituent elements, components or combinations thereof.

The term “or” used in embodiments of the disclosure includes any or all of combinations of listed words. For example, the expression “A or B” may include A, may include B, or may include both A and B.

The message names herein are merely examples, and other message names may be used. Terms such as “first” and “second” included in the message names herein are merely examples of the messages, and do not represent the performing order. The steps in individual processes may be performed in combination with each other or inde-pendently. The performing steps of each process are merely examples, and other possible performing orders are not excluded.

The embodiments described herein are embodied as sets of instructions stored as electronic data in one or more storage media. Specifically, the instructions may be provided on a transitory or non-transitory computer-readable media. When executed by the processor, the processor is configured to perform the various methods described in the following embodiments. In this way, the methods may be computer-implemented methods.

The disclosure provides the systems and methods to manage and orchestrate multiple intelligent systems (AI models) distributed at different domains and layers of the network in a unified manner, and to co-ordinate the resulting actions from those AI models.

In particular, it is proposed that an overall AI management entity (function), is responsible for service and management of all AI models across different network layers and domains. In essence, this means to extract all AI management functions, previously as functions in individual network domains and layers (e.g., NWDAF in Core network and a centralized RAN AI management function at the RAN, or xApp management in near-RT RIC and rApp management in non-RT RIC), to form a unified AI layer, that is able to interact with all AI models (or AI management functions) simultaneously, to facilitate the AI model management and orchestration across the layers, and to allow the resulting actions from those AI models to be combined, so as to resolve any conflicting actions, to prioritise some results over others, and to achieve a full, end-to-end optimization of the network's performance and behavior based on full knowledge of the cumulative intent of all AI models, rather than focusing on individual AI models.

It is understood that the AI management entity/function can be an intelligent entity itself, i.e., one or multiple AI models may be deployed in the AI management entity.

Similar to local AI management (e.g., xApp management in near-RT RIC), the AI management entity may include and/or interact with network management and orchestration, directly or indirectly control, in addition to the AI models, one or multiple network functions at different layers and components of the network.

Such a new management entity (function), can be realized with or without the existing AI management functions in individual network layers and domains. Both cases are considered in the disclosure, where—

Embodiment #1: The new AI management function interfaces with AI management functions of each network domain/layer

Embodiment #2: The new AI management function interfaces with AI models in different layers directly

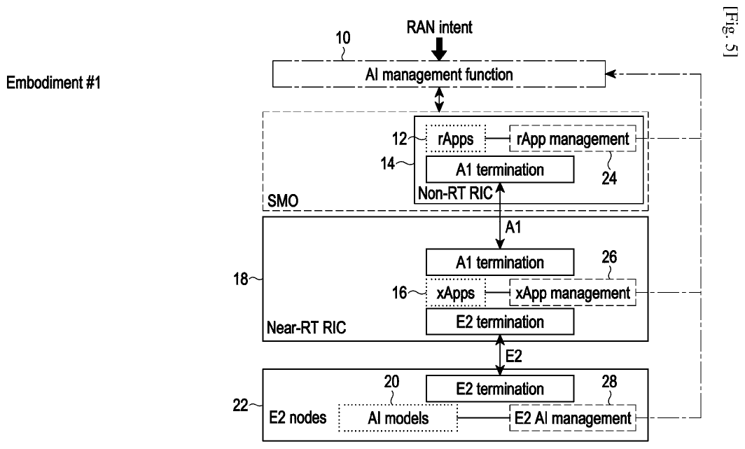

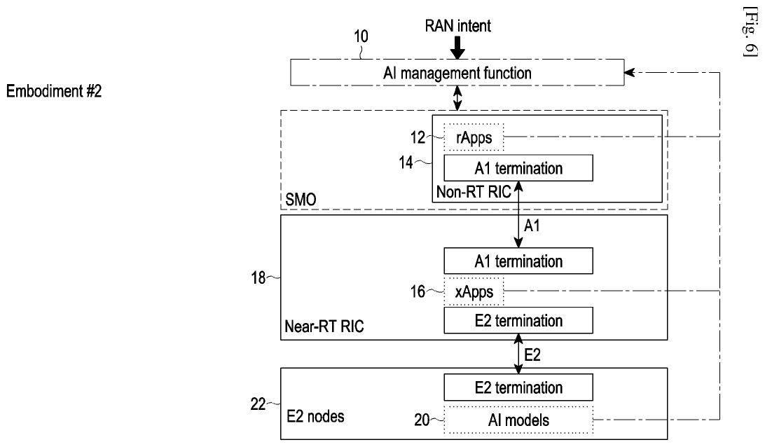

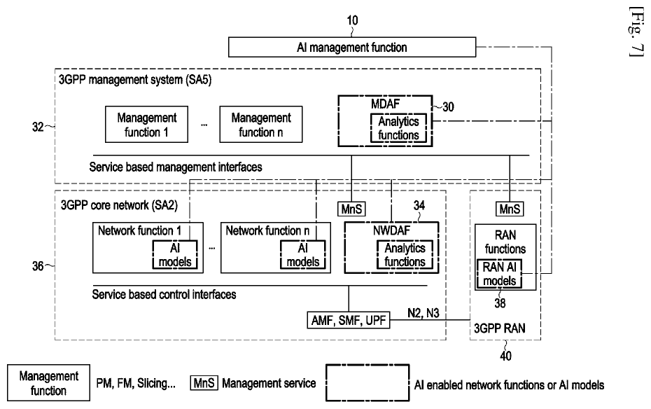

FIGS. 5 and 6 illustrate the concept of Embodiment #1 and #2, respectively. FIG. 7 is an equivalent of Embodiment #2 under 3GPP architecture. It is understood that it is straightforward to extend the concept of Embodiment #1 under 3GPP architecture as well, if the same AI management functions exist in 3GPP.

In accordance with embodiments of the disclosure, there is a new AI management entity (function), that is responsible for AI model management and orchestration across the layers and network domains. There is also new interfaces to and from the new AI management entity (function), that facilitate the communication between the new AI management entity (function), and the other AI models in different layers and domains of the network. Such a communication could be via their individual AI management functions (Embodiment #1) or with the AI models directly (Embodiment #2).

The new AI management entity (function) may be used to facilitate the conflict mitigation between xApps and rApps. For example, there may be an energy saving rApp and a handover optimization xApp. In the case when energy saving takes priority, the overall AI management entity (function) may decide to prioritize the energy saving rApp, and deprioritize handover optimization, possibly at the cost of throughput degradation.

FIG. 5 illustrates a block diagram of an O-RAN communications network embodying a controller according to one or more embodiments.

With further reference to FIG. 5, the AI management function may be called a controller 10 for controlling first and second artificial intelligence models at different levels of a communication network. As will be appreciated from the disclosure herein, the controller 10 includes an input configured to receive status information from the first and second artificial intelligence models, and to receive network information from the communications network; a determination module configured to determine an action to be performed by the first and/or the second artificial intelligence models based on the received status information and the received network information; and an output configured to sending a control signal to the first and/or the second artificial intelligence models to perform the determined action. The input is also configured to receive an acknowledgment from the first and/or second artificial intelligence models that the action has been performed.

The input and output may be physical or software inputs and outputs. The determination module may be a software component or a hardware component. The controller 10 therefore may be a software component or a hardware component. The controller 10 may be a heuristics model with hard-coded instructions. Alternatively, the controller 10 may include one or more learned models, e.g. machine learning models such as neural networks.

The communications network is an open radio access network, O-RAN, and wherein the first artificial intelligence model is one of a first network automation tool, rApp, 12 at a level of a non-real-time RAN intelligent controller, non-RT RIC, 14 a second network automation tool, xApp, 16 at a level of a near-real-time RAN intelligence controller, near-RT RIC, 18 or an artificial intelligence model 20 at a level of an E2 node, 22 and wherein the second artificial intelligence model is a different one of the first network automation tool, rApp, 12 at a level of a non-real time RAN intelligent controller, non-RT RIC 14, a second network automation tool, xApp, 16 at a level of a near-real time RAN intelligence controller, near-RT RIC, 18 or an artificial intelligence model, 20 at a level of an E2 node 22.

The output is communicatively linked indirectly with the first and the second artificial intelligence models via a respective management module. The management module of the first network automation tool, rApp, 12 is a first network automation tool, rApp, management module 24. The management module of the second network automation tool, xApp, 16 is a second network automation tool, xApp management module, 26. The management module of the artificial intelligence model, 20 at a level of the E2 node 22 is an E2 artificial intelligence model management module, 28.

FIG. 6 illustrates a block diagram of an O-RAN communications network embodying a controller according to one or more embodiments.

With reference to FIG. 6, the features described above in relation to FIG. 5 are the same except the output of the controller is communicatively linked directly with the first and second artificial intelligence model. In other words, there is no management module for each of the artificial intelligence models.

The communications network is an open radio access network, O-RAN, and wherein the first artificial intelligence model is one of a first network automation tool, rApp, 12 at a level of a non-real-time RAN intelligent controller, non-RT RIC, 14 a second network automation tool, xApp, 16 at a level of a near-real-time RAN intelligence controller, near-RT RIC, 18 or an artificial intelligence model 20 at a level of an E2 node, 22 and wherein the second artificial intelligence model is a different one of the first network automation tool, rApp, 12 at a level of a non-real-time RAN intelligent controller, non-RT RIC 14, a second network automation tool, xApp, 16 at a level of a near-real-time RAN intelligence controller, near-RT RIC, 18 or an artificial intelligence model, 20 at a level of an E2 node 22.

FIG. 7 illustrates a block diagram of a 3GPP communications network embodying a controller according to one or more embodiments. With reference to FIG. 7, the communications network is a third-generation partnership project, 3GPP, network, wherein the first artificial intelligence model is one of a management data analytics function, MDAF, 30 at a level of a service layer 32 of the 3GPP network, a network data analytics function, NWDAF, 34 at a level of a core network layer 36 of the 3GPP network, and a radio access network artificial intelligence model, RAN, AI model, 38 at a level of a radio access network, RAN, 40 of the 3GPP network. The second artificial intelligence model is a different one of a management data analytics function, MDAF, 30 at a level of a service layer 32 of the 3GPP network, a network data analytics function, NWDAF, 34 at a level of a core network layer 36 of the 3GPP network, and a radio access network artificial intelligence model, RAN, AI model, 38 at a level of a radio access network, RAN, of the 3GPP network.

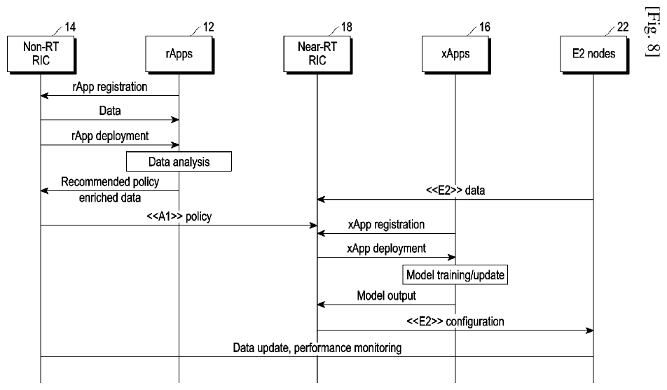

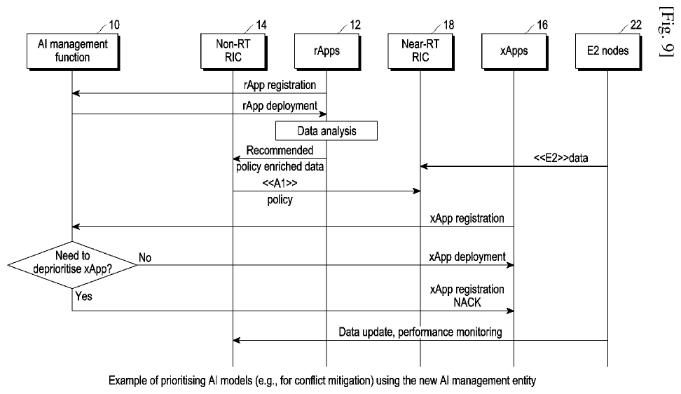

How the new AI management entity (function) would be used to address such an example is illustrated in FIG. 8 and FIG. 9.

FIG. 8 illustrates a flow chart of operations performed in an O-RAN communications network

FIG. 8 gives an example of the existing hierarchical messaging flow between different AI models (xApps and rApps) to their respective AI management function (located within Near-RT RIC and non-RT RIC), and information is passed via A1 and E2 interfaces whereas no interaction on the xApp/rApp level.

FIG. 9 illustrates a flow chart of operations performed in an O-RAN communications network according to one or more embodiments

FIG. 9 gives an example of how conflict mitigation between xApps and rApps can be enabled by the new AI management entity (function) and corresponding interfaces, through prioritising one or multiple xApps/rApps.

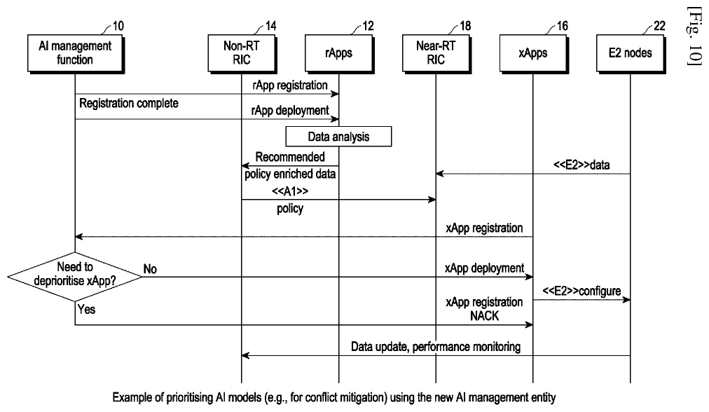

FIG. 10 illustrates a flow chart of operations performed in an O-RAN communications network according to one or more embodiments.

FIG. 10 gives an alternative example where rApp registration request comes from the AI management entity (function), while the xApp registration request comes from xApp itself. Such a situation can happen when, for example, when an SLA assurance intent requires an rApp to be deployed instantly to meet a critical SLA, while at the same time, the near-RT RIC wants to optimize handover, hence requested registration/initiation of a handover xApp. The AI management entity (function) then decides that handover optimization xApp needs to be deprioritized—it could be because the system computational power does not allow the two (multiple) AI models simultaneously at the time, or the execution of this xApp will impact the critical SLA that the rApp is trying to achieve. In such a case, the AI management entity (function) deprioritizes the xApp, and delays or removes the registration of the xApp.

The same model can be applied to 3GPP based network, where the SLA assurance may be performed in a core network (e.g., via NWDAF), while the handover optimization may be performed at the RAN (e.g., via a RAN AI model). The AI management entity (function) may decide to deprioritize RAN AI, following the same procedure as shown in FIG. 10.

It is understood that such a model can be easily extended to e.g., manage the life cycle of xApps, rApps, and AI models applied via NWDAF and MDAF; instruct AI models to pass analytics, data, and knowledge; instruct AI models to update their training under the context change of the network; instruct AI models to split their training and inference across the network. FIG. 9a gives another example of managing and coordinating the training and inference of the AI models by using the new AI management entity (function). There is no existing mechanism in the current network architecture that would enable the management of AI models cross layers, to address the examples of issues identified above.

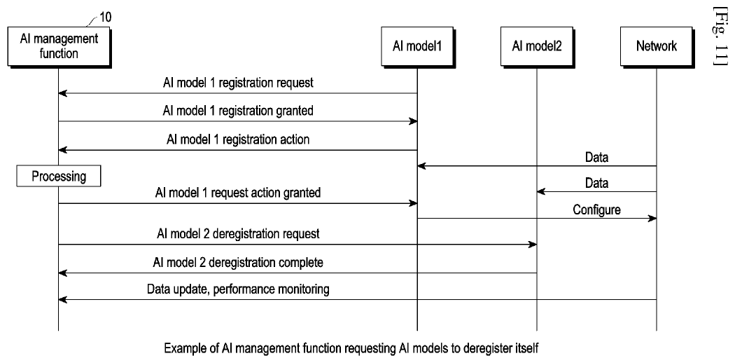

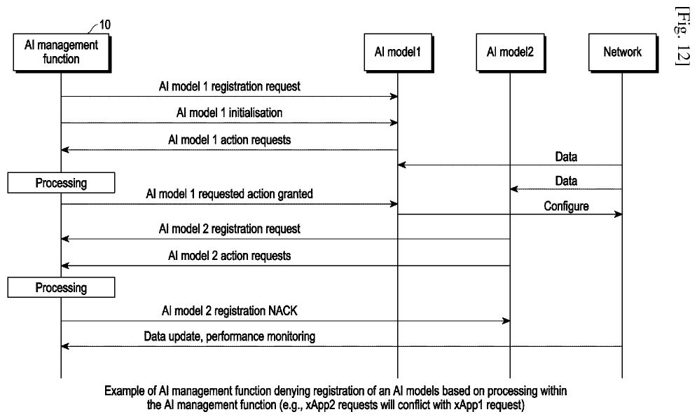

FIGS. 11 and 12 give examples of data flow between the new AI management function and multiple AI models. It is noted that the two AI models used in the example can be in the same or different layers and domains of the network. For example, AI model 1 may sit at the RAN, while AI model 2 may sit at the Core network. It is also noted that the concept can be straightforwardly extended to cases with more than two AI models, and under different network architecture including 3GPP and O-RAN network. In addition, the figures illustrate the cases where AI models interacting with the central AI management function directly. It is straightforward, especially according to FIG. 10, it can be easily extended to the cases where the AI models will interact with the central AI management function via their respective local AI management function (e.g., near-RT RIC). It is also noted that in the following data flow, registration/deregistration requests (and other requests that are applicable) may be initiated by the central AI management function, or the AI models.

FIG. 11 illustrates a flow chart of operations performed in a communications network according to one or more embodiments.

Data flow (and related IEs) in FIG. 11 is described as follows:

### <<Initial States>>: AI Model 2 in Operation

Step 1101: AI model 1 (ModelID, DomainID) sends request to AI management function requesting to register (RegistrationRequest)

Step 1102: AI management function grants the registration request of AI model 1 (RegistrationGranted)

Step 1103: AI model 1 receives the granted registration and requests to AI management function one or multiple intended action (e.g., requesting 10 PRBs for gNB 1) (ActionRequest)

Step 1104: AI management function does relative processing, including calculating the intended network status as a result of the intended action from AI model 1. As a result of the processing

Step 1105a: AI management function grants the request from AI model 1 according to the process within the AI management function (ActionGranted)

Step 1105b: AI management function requests AI model 2 to stop the configuration and deregister itself while AI model 1 is performing (DeRegistrationRequest)

Step 1105c: AI model 2 deregistrates and send DeregistrationComplete to AI management function

Step 1106: AI model 1 does the corresponding configuration to the network according to its actions

FIG. 12 illustrates a flow chart of operations performed in a communications network according to one or more embodiments.

Data flow (and related IEs) in FIG. 12 is described as follows:

Step 1: AI management function requests AI model 1 (ModelID, DomainID) to register (e.g., when a given network KPI or intent needs to be met) via RegistrationRequest

Step 2: AI management function initiate AI model 1 via ModelInitialisation

Step 3: AI model 1 receives the registration and initialization requests, and send to AI management function one or multiple intended actions (e.g., requesting 10 PRBs for gNB 1) (ActionRequest)

Step 4: AI management function does relative processing, including calculating the intended network status as a result of the intended action from AI model 1. As a result of the processing

Step 5: AI management function grants the request from AI model 1 according to the process within the AI management function (ActionGranted)

<<States update: AI model 2 requests registration due to a local update, e.g., handover optimization AI needed at the RAN) (RegistrationRequest, ModelID) and sends intended actions (e.g., requesting 20 PRBs for gNB2)

Step 6: AI management function does relative processing, including calculating the intended network status as a result of the intended action from AI model 2. As a result of the processing

Step 7: AI management function does not grant the registration request of AI model 2 and sends RegistrationNACK to AI model 2.

From the disclosure relating to FIGS. 8 to 12, it will be appreciated that the input is configured to receive a request for action from the first and/or the second artificial intelligence algorithms, wherein the determination module is configured to determine the action to be performed by the first and/or the second artificial intelligence models, based on the received status information and the received network information, in response to the received request. In addition, the status information comprises one or more items of status information selected from a list of status information including: a state, information on shared layers, priority, and intent of actions. A state may be active or inactive, operating or not operating, etc. A shared layer may be a layer shared by the first and the second AI models or may refer to the first or the second AI model using more than one layer. In other words, for example, the first (or the second) AI model may operate on multiple layers of the communications network. Compared to other artificial intelligence models. By priority, we mean whether actions of one model take precedence over actions of another model. Intent of actions may refer to an in-dication of what actions the respective AI model intends to perform.

The intent of actions comprises a number of physical resource blocks of the communications network that the first or the second AI model intends to use when performing the action.

The action comprises one or more actions selected from a list of actions including: initializing the first and/or second artificial intelligence model, prioritising the first and/or the second artificial intelligence model, deprioritising the first and/or the second artificial intelligence model, registering the first and/or the second artificial intelligence model, deregistering the first and/or the second artificial intelligence model, mitigating conflict between the first and the second artificial intelligence models, managing a life cycle of the first and/or the second artificial intelligence models, and placement of the first and or the second artificial intelligence models.

The first and or the second artificial intelligence models may be machine learning models, wherein the machine learning models may be neural networks.

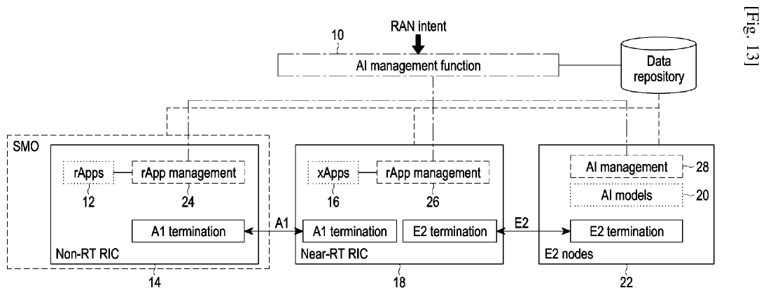

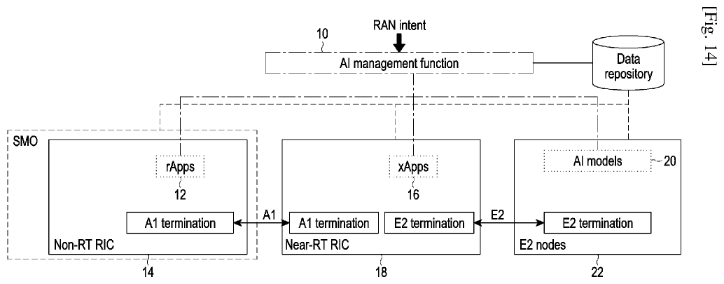

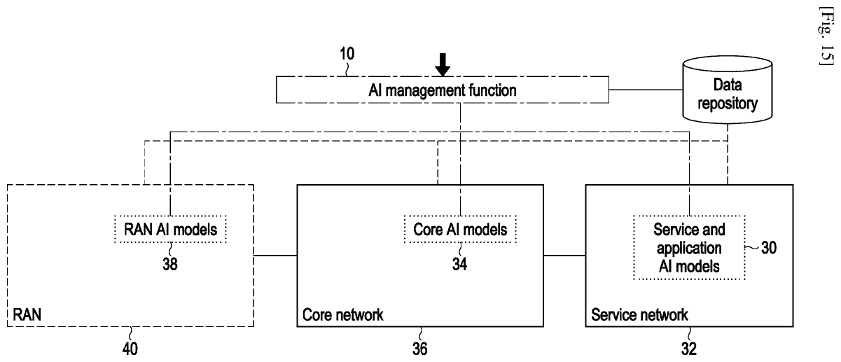

FIGS. 13 to 15 give an alternative representation of the new AI management entity (function), and their interactions with different layers and domains of the network, under the O-RAN and 3GPP architecture, respectively. It is noted that the data repository facilitates the communication and interaction of the AI models as well as with the AI management entity (function). Data storage, exchange, and publishing is out of the scope of the disclosure. It is understood that although the figures only included part of the network, the technology disclosed in this disclosure can be easily extended to include the other domains, parts, and components of the network, e.g., the AI management entity (function) can also manage AI models at UEs simultaneously.

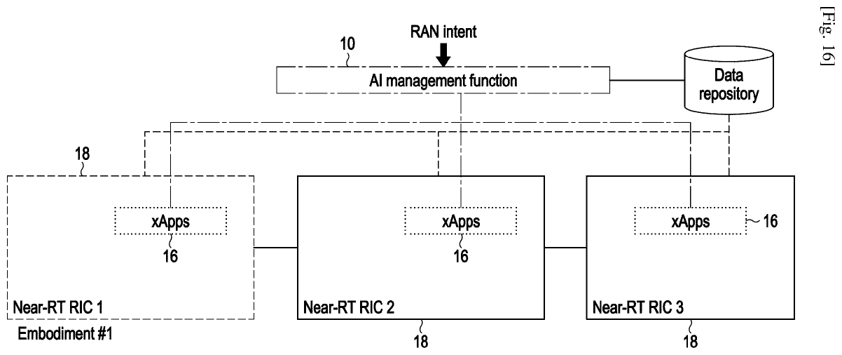

FIG. 16 illustrates a block diagram of an O-RAN communications network embodying the controller according to one or more embodiments

FIG. 16 gives an example where the overarching new AI management entity (function) may manage and orchestrate AI models across network components from different vendors. This helps to resolve an issue when an xApp 16 in vendor A's near-RT RIC 1 may conflict with the decision made by an xApp in vendor B's near-RT RIC 2. It is understood that such an extension can be easily applied to 3GPP based network architecture, where the AI management entity (function) can manage AI models in eNBs/gNBs provided by different vendors, different core networks provided by different vendors, as well as from a mixed eNBs/gNBs and core networks from different vendors.

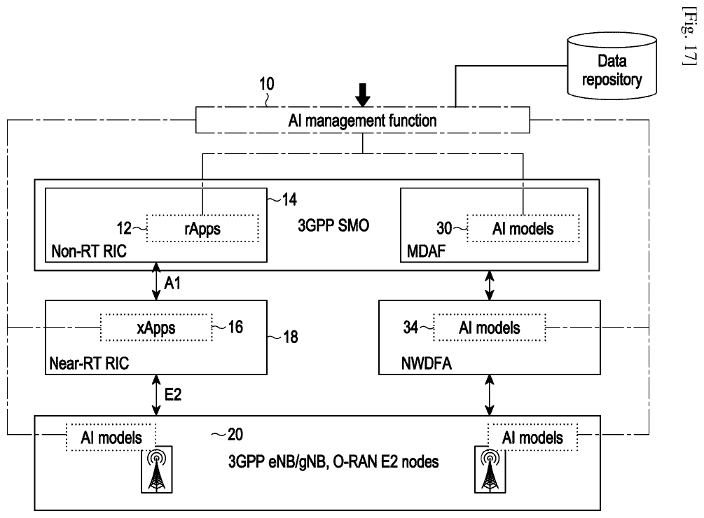

FIG. 17 illustrates a block diagram of a communications network embodying the controller according to one or more embodiments.

FIG. 17 gives an example where the overarching new AI management entity (function) may manage and orchestrate AI models across the network end to end, including these embedded under an O-RAN and 3GPP architecture. Under such a context, it is straightforward to infer that the AI management entity (function) may interact directly with AI models (e.g., analytics functions in NWDAF), and/or with their respective local AI management functions if exists (e.g., conflict mitigation function in O-RAN near-RT RIC).

A new network function that operates the AI models in a telecommunication network, that manages and orchestrates AI models across the network end to end, comprising one of the following operations of at least one AI model, prioritize and deprioritize, conflict mitigation, acknowledge the success and failure of the registration/deployment of the AI models across the network, according to the actions and decisions from different AI models.

The proposed new AI management entity (function) facilitates the management and orchestration of AI models across the network, in different domains and layers of the network. The advantage is it can detect when potential issues between any AI function across the whole network happen.

Current network either does not have AI management functions, or has separate AI management function for specific layer and domain of the network. The interaction and management of these AI models are on a layer by layer, domain by domain approach. It does not allow simultaneously management of the AI models in different domains of the network, e.g., a decision made by a RAN AI has to be passed to the core network via a pre-defined interface, while the initialization of the RAN AI has to be performed by a RAN control function. Such an existing mechanism does not facilitate the management of AI models across the layers, e.g., in a situation when a Core AI action conflicts with a RAN AI action. Conflict mitigation, if any (e.g., in O-RAN) is only done on the xApp level, or the rApp level, and not in the cross rApp and xApp level.

The AI management entity (function) proposed in the disclosure, and the corresponding interfaces, allows overarching use cases where AI models of different layers and domains of the network need to be registered/initiated/deployed simultaneously. It also enables the prioritization and de-prioritization of given AI models, according to the actions and results generated by the AI models from a different layer/domain of the network.

The proposed entity and interfaces are to be disclosed in coming O-RAN nGRG RS02-2022-RI01 Research Item: Native AI Arch. Of O-RAN. And RS03 native AI.

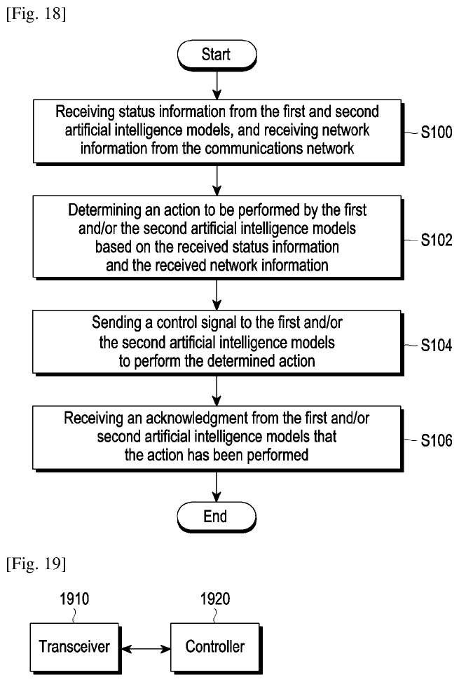

FIG. 18 illustrates a flow chart summarising a method of controlling first and second artificial intelligence models in a communications network according to one or more embodiments.

With reference to FIG. 18, the foregoing modes of operation and methods may be summarised as including: receiving S100 status information from the first and second artificial intelligence models, and receiving network information from the communications network; determining S102 an action to be performed by the first and/or the second artificial intelligence models based on the received status information and the received network information; sending S104 a control signal to the first and/or the second artificial intelligence models to perform the determined action; and receiving S106 an acknowledgment from the first and/or second artificial intelligence models that the action has been performed.

In an embodiment, the method includes: receiving, from a second network node and a third network node, status information; receiving, from a fourth network node, network information; determining an action to be performed by the second network node and the third network node based on the status information and the network information; transmitting, to the second network node and the third network node, a control signal to perform the determined action; and receiving, from the second network node and the third network node, an acknowledgment that the action is performed, wherein the second network node and the third network node comprise artificial intelligence function or data analytics function.

In an embodiment, the status information comprises at least one item of status information selected from a list of status information including: a state, information on shared layers, priority, and intent of actions, the intent of actions comprises a number of physical resource blocks of the communication system that the second network node or the third network node intends to use when performing the action.

In an embodiment, the action comprises at least one action selected from a list of actions including initializing at least one of the second network node and the third network node, prioritising at least one of the second network node and the third network node, deprioritising at least one of the second network node and the third network node, registering at least one of the second network node and the third network node, deregistering at least one of the second network node and the third network node, mitigating conflict between at least one of the second network node and the third network node, and managing a life cycle of at least one of the second network node and the third network node, and placement of at least one of the second network node and the third network node.

In an embodiment, the second network node and the third network node are two of a first network automation tool (rApp) in a non-real time RAN intelligent controller (non-RT RIC), a second network automation tool (xApp) in a near-real time RAN intelligence controller (near-RT RIC), and an artificial intelligence model in an E2 node, and the second network node and the third network node are different from each other.

In an embodiment, the first network node is communicatively linked directly with the second network node and the third network node. In an embodiment, the first network node is communicatively linked indirectly with the second network node and the third network node via a respective management module, and a first management module of the first network automation tool (rApp) is a first network automation tool (rApp) management module, a second management module of the second network automation tool (xApp) is a second network automation tool (xApp) management module, and a third management module of the artificial intelligence model at a level of the E2 node is an E2 artificial intelligence model management module.

In an embodiment, the communication system is a third-generation partnership project, 3GPP, system, the second network node and the third network node are two of a management data analytics function (MDAF) in a service layer of the 3GPP network, a network data analytics function (NWDAF) in a core network layer of the 3GPP network, and a radio access network (RAN) artificial intelligence model (AI model) in a radio access network (RAN) of the 3GPP network, and the second network node and the third network node are different from each other.

Whilst the following embodiments provide specific illustrative examples, those illustrative examples should not be taken as limiting, and the scope of protection is defined by the claims. Features from specific embodiments may be used in combination with features from other embodiments without extending the subject matter beyond the content of the present disclosure.

Whilst the foregoing embodiments have been described to illustrate the subject matter of the present disclosure, the features of the embodiments are not to be taken as limiting the scope of protection. For the avoidance of doubt, the scope of protection is defined by the following claims.

FIG. 19 illustrates a schematic diagram of a network node for AI management function according to an embodiment of the disclosure.

Referring to FIG. 19, the network node according to an embodiment of the disclosure includes a transceiver (1910), and a controller (or a processor) (1920).

According to another aspect of the present disclosure, there is provided a first network node for artificial intelligent (AI) management function in a communication system. The first network node comprises a transceiver; and a controller (or a processor) coupled with the transceiver and configured to perform operations in the method as described above.

The present disclosure may be understood with reference to the following clauses.

Clause 1: A system including an AI management network function for managing and operating the AI models across the networks end to end, addressing one or multiple of the operations of AI models, including but not limited to: conflict mitigation, prioritization, and de-prioritisation, the functionalities including one or multiple of the followings: receiving information of multiple AI models across different layers and domains of the network. Information includes but not limited to: states, shared layers, priority, and intent of actions (e.g., requested number of PRBs); processing the received information within the AI management function; determining, at least one decisions required for the operations of the AI models, with respect to at least one set of network and computational KPIs, based on functions performed by the set of AI models; operations include, but not limited to: initialization of one or multiple of AI models, prioritisation and deprioritisation, registration and deregistration, conflict mitigation, life cycle management, placement of partial, one or multiple of AI models; requesting, from the AI management function, the determined actions towards one or multiple of the AI models; receiving the acknowledge of such actions being performed from the AI models, and updated network status and information from AI models; The updated information includes but not limited to: states, priority, and intent of actions (e.g., requested number of PRBs).

Clause 2: The system of Clause 1, wherein the interfaces enable the interacting of the AI models to the AI management function, via the interfaces between AI models and the new AI management function.

Clause 3: The system of Clause 1, wherein the interfaces enabling the interacting of the AI models to the AI management function, via the interfaces between local AI management functions and the end to end AI management function.

Clause 4: Requests in Clause 1 can be initiated by the AI models (e.g., request for registration), or initiated by the AI management function (e.g., request one or more AI models to be registered/to function).

Clause 5: The system of Clause 1 where the AI management function's decision takes priority over all AI models across the network.

Example functions of AI management function in FIG. 9 and FIG. 10

Example data flow in FIGS. 11 and 12

1. A first network node for artificial intelligent (AI) management function in a communication system, the first network node comprising:
a transceiver; and
a controller coupled with the transceiver and configured to:
receive, from a second network node and a third network node, status information,
receive, from a fourth network node, network information,
determine an action to be performed by the second network node and the third network node based on the status information and the network information,
transmit, to the second network node and the third network node, a control signal to perform the determined action, and
receive, from the second network node and the third network node, an acknowledgment that the action is performed,
wherein the second network node and the third network node comprise artificial intelligence function or data analytics function.

2. The first network node of claim 1, wherein the status information comprises at least one item of status information selected from a list of status information including: a state, information on shared layers, priority, and intent of actions, and
wherein the intent of actions comprises a number of physical resource blocks of the communication system that the second network node or the third network node intends to use when performing the action.

3. The first network node of claim 1, wherein the action comprises at least one action selected from a list of actions including:
initializing at least one of the second network node and the third network node,
prioritising at least one of the second network node and the third network node,
deprioritising at least one of the second network node and the third network node,
registering at least one of the second network node and the third network node,
deregistering at least one of the second network node and the third network node,
mitigating conflict between at least one of the second network node and the third network node, and
managing a life cycle of at least one of the second network node and the third network node, and placement of at least one of the second network node and the third network node.

4. The first network node of claim 1,
wherein the second network node and the third network node are two of a first network automation tool (rApp) in a non-real time RAN intelligent controller (non-RT RIC), a second network automation tool (xApp) in a near-real time RAN intelligence controller (near-RT RIC), and an artificial intelligence model in an E2 node, and
wherein the second network node and the third network node are different from each other.

5. The first network node of claim 4, wherein the transceiver is communicatively linked directly with the second network node and the third network node.

6. The first network node of claim 4, wherein the transceiver is communicatively linked indirectly with the second network node and the third network node via a respective management module,
wherein a first management module of the first network automation tool (rApp) is a first network automation tool (rApp) management module, wherein a second management module of the second network automation tool (xApp) is a second network automation tool (xApp) management module, and wherein a third management module of the artificial intelligence model at a level of the E2 node is an E2 artificial intelligence model management module.

7. The first network node of claim 1, wherein the communication system is a third-generation partnership project (3GPP) system,
wherein the second network node and the third network node are two of a management data analytics function (MDAF) in a service layer of the 3GPP network, a network data analytics function (NWDAF) in a core network layer of the 3GPP network, and a radio access network (RAN) artificial intelligence model (AI model) in a radio access network (RAN) of the 3GPP network, and
wherein the second network node and the third network node are different from each other.

8. The first network node of claim 1, wherein the controller is configured to
receive a request for action from the second network node and the third network node, and
determine the action to be performed by the second network node and the third network node, based on the received status information and the received network information, in response to the request.

9. A method of first network node for artificial intelligent (AI) management function in a communication system, the method comprising:
receiving, from a second network node and a third network node, status information;
receiving, from a fourth network node, network information;
determining an action to be performed by the second network node and the third network node based on the status information and the network information;
transmitting, to the second network node and the third network node, a control signal to perform the determined action; and
receiving, from the second network node and the third network node, an acknowledgment that the action is performed;
wherein the second network node and the third network node comprise artificial intelligence function or data analytics function.

10. The method of claim 9, wherein the status information comprises at least one item of status information selected from a list of status information including: a state, information on shared layers, priority, and intent of actions, and
wherein the intent of actions comprises a number of physical resource blocks of the communication system that the second network node or the third network node intends to use when performing the action.

11. The method of claim 9, wherein the action comprises at least one action selected from a list of actions including:
initializing at least one of the second network node and the third network node,
prioritising at least one of the second network node and the third network node,
deprioritising at least one of the second network node and the third network node,
registering at least one of the second network node and the third network node,
deregistering at least one of the second network node and the third network node,
mitigating conflict between at least one of the second network node and the third network node, and
managing a life cycle of at least one of the second network node and the third network node, and placement of at least one of the second network node and the third network node.

12. The method of claim 9,
wherein the second network node and the third network node are two of a first network automation tool (rApp) in a non-real time RAN intelligent controller (non-RT RIC), a second network automation tool (xApp) in a near-real time RAN intelligence controller (near-RT RIC), and an artificial intelligence model in an E2 node, and
wherein the second network node and the third network node are different from each other.

13. The method of claim 12, wherein the first network node is communicatively linked directly with the second network node and the third network node.

14. The method of claim 12, wherein the first network node is communicatively linked indirectly with the second network node and the third network node via a respective management module, and
wherein a first management module of the first network automation tool (rApp) is a first network automation tool (rApp) management module, wherein a second management module of the second network automation tool (xApp) is a second network automation tool (xApp) management module, and wherein a third management module of the artificial intelligence model at a level of the E2 node is an E2 artificial intelligence model management module.

15. The method of claim 9, wherein the communication system is a third-generation partnership project (3GPP) system,
wherein the second network node and the third network node are two of a management data analytics function (MDAF) in a service layer of the 3GPP network, a network data analytics function (NWDAF) in a core network layer of the 3GPP network, and a radio access network (RAN) artificial intelligence model (AI model) in a radio access network (RAN) of the 3GPP network, and
wherein the second network node and the third network node are different from each other.
